(19) United States
(12) Patent Application Publication
(10) Pub. No.: US 2025/0136748 A1
(43) Pub. Date: May 1, 2025

(54) CATIONICALLY POLYMERIZABLE FLAME RETARDANT COMPOSITIONS

(71) Applicant: DELO Industrie Klebstoffe GmbH & Co. KGaA, Windach (DE)

(72) Inventors: Julian BAUER, Windach (DE); Kilian RAUCHEISEN, Windach (DE); Vitalij SCHIMPF, Windach (DE); Dennis HÜBNER, Windach (DE)

(21) Appl. No.: 18/835,551

(22) PCT Filed: Jan. 17, 2023
(86) PCT No.: PCT/EP2023/050935

§ 371 Date: Aug. 2, 2024

(30) Foreign Application Priority Data
Feb. 4, 2022 (DE) 10 2022 102 650.7

(51) Int. Cl. C08G 59/22; C08G 59/24; C08G 59/68; C08K 5/523; C08K 5/5313; C09D 7/63; C09D 163/00; C09J 5/06; C09J 11/06; C09J 163/00

(52) U.S. Cl. CPC C08G 59/226; C08G 59/245; C08G 59/686; C08G 59/687; C09D 7/63; C09D 163/00; C09J 5/06; C09J 11/06; C09J 163/00; C08K 5/523; C08K 5/5313; C09J 2463/00

(57) ABSTRACT

The present disclosure provides a cationically polymerizable composition having a high degree of flame retardancy in the cured state. The cationically polymerizable composition is liquid at room temperature and includes: (A) at least one cationically polymerizable component in a proportion of 15 to 80% by weight; (B) at least one initiator for cationic polymerization; (C) at least one flame retardant, with the flame retardant comprising at least 10% by weight of an organophosphinate, based on the total weight of the composition; and (D) 0 to 60% by weight of a filler, wherein the solids content from components (C) and (D) is at most 70% by weight, each based on the total weight of the composition.

### FIELD OF DISCLOSURE

The present disclosure relates to a cationically polymerizable composition and flame retardant materials made thereof.

In addition, the present disclosure relates to a method for manufacturing flame retardant bondings, encapsulations and/or coatings based on the cationically polymerizable compositions.

### BACKGROUND

In the state of the art there are numerous approaches to formulate curable compositions with flame retardancy. The flame retardants used act as inhibitors for combustion processes via various mechanisms.

WO 2005/054330 A1 discloses radiation-curable formulations to manufacture 3D-printed objects meeting the requirements of the UL94 V-0 fire test. The resins used comprise cationically and, in addition, radically polymerizable components. The disclosure provides the combination of at least two flame retardants selected from two different substance classes. Bromated compounds, phosphorus-containing compounds and/or aluminum salts are preferred. The formulations described in the examples always contain a bromine content of at least 10%, up to about 30%, based on the organic matrix. Today, the use of bromated flame retardants is outdated for ecotoxicological reasons. Moreover, such compositions are not compatible with the requirement of halogen-free products in the electronics industry.

U.S. Pat. No. 4,970,135 A discloses flame retardant radiation-curable formulations based on (meth)acrylates. Again, bromated (meth)acrylates, preferably based on bromated phenols, are contained as necessary constituents to achieve sufficient flame protection.

Halogen-free flame retardant epoxy compositions are described in EP 1 268 665 B1. They comprise, as curing agents, phenolic resins and, as flame retardants, phosphorus-containing compounds. The latter comprise phosphorus-containing epoxy resins, unfunctionalized phosphorus compounds and products from the reaction between epoxy resins and phosphorus-containing compounds. Furthermore, an additional flame-protection additive based on red phosphorus, polyphosphates or aluminum trihydrate is suggested.

EP 0 814 121 B1 describes epoxy amine compositions which achieve flame retardancy by adding heat-expandable graphite and at least one plasticizer. In a preferred embodiment, bromated compounds are added as well. Moreover, the use of further flame retardants from the group of metal borates, liquid phosphate and/or phosphonate esters and aluminum trihydrate is suggested in the examples. None of the exemplary formulations achieves the required flame protection with less than one combination of five different substance classes.

Furthermore, due to the high content of solids and/or compounds of high molecular weight, flowability of the compositions is low.

WO 2020/171186 A1 describes cationically polymerizable compositions with one or more phosphoric acid esters used in proportions of at most 5% by weight, based on the total weight. The phosphoric acid esters serve to improve the resistance in final use. Flame retardancy is neither intended nor disclosed.

JP 2012 008 221 A describes a laminating material for a fiber optic based on a photo-curable acrylate formulation which additionally contains a filler based on an alkyl phosphinate. The cured compositions do not achieve flame retardancy according to the UL94 V-0 standard.

EP 2 900 779 B1 discloses thermally conductive compositions based on cationically photo-curable epoxides. The compositions contain at most 25% by weight of halogen-free flame retardants, based on the total weight of the composition. The flame retardants are selected from the group of phosphor-containing compounds, ammonium phosphates, metal borates and graphite. The compositions achieve the UL94 V-0 flame retardancy standard by additionally using high proportions of unreactive inorganic fillers as a thermally conductive material. Due to the high content of solids and components of high molecular weight the compositions are difficult to dose at room temperature and unsuitable as encapsulating compositions. In all examples, the compositions are diluted with high proportions of solvents to make the compositions processable. Use as a liquid adhesive is not intended; instead, use of the compositions as a tape is intended.

Cationically polymerizable compositions based on epoxy resins are described, for example, in EP 0 066 543 A2, WO2019/002360 A1, EP 3 088 465 B1 and U.S. Pat. No. 6,455,121 B1.

The formulations disclosed can be cured by exposure to heat and/or actinic radiation.

### SUMMARY

The present disclosure is to avoid the disadvantages of the compositions known in the state of the art and to provide reactive cationically polymerizable compositions allowing, in the cured state, a high degree of flame retardancy without relying on halogenated constituents.

The compositions according to the present disclosure are solvent-free and, due to their low viscosity, particularly suitable as an encapsulating composition in fields in which flame retardancy is required.

As opposed to formulations based on (meth)acrylates, the cured compositions, apart from high strength, exhibit high resistance to temperature and moisture exposure.

Advantageous embodiments of the compositions according to the present disclosure are stated in the sub-claims, which can be optionally combined with each other.

The present disclosure further relates to a method for encapsulating, bonding or coating substrates using the compositions according to the present invention.

The compositions according to the present disclosure are solvent-free, liquid at room temperature and comprise the following components:
(A) at least one cationically polymerizable component in a proportion of 15 to 80% by weight;
(B) at least one initiator for cationic polymerization;
(C) at least one flame retardant, with the flame retardant comprising at least 10% by weight of an organophosphinate, based on the total weight of the composition; and
(D) 0 to 60% by weight of a filler;
with the solids content from components (C) and (D) being at least 70% by weight, each based on the total weight of the composition.

The compositions according to the present disclosure can be cured by heat and/or exposure to actinic radiation. Preferably, they are present as a one-pack composition.

The compositions according to the present disclosure exhibit high reactivity in cationic polymerization while having high flame retardancy in the cured state. The flame retardancy achievable preferably corresponds to the UL94 V-0 standard.

The present disclosure is based on the finding that flowable compositions exhibiting both high flame retardancy and unchangedly high reactivity as compared to non-flame retardant compositions can be formulated by selecting organophosphinates as the flame retardant (C). Due to the high reactivity of the compositions, high curable layer thicknesses can be achieved, in particular during photocuring.

Furthermore, the high reactivity of the compositions contributes to the mechanical properties of the cured compositions being reliably adjustable by selecting the cationically polymerizable component (A) and being variable over a wide range with high formulation flexibility. The use of epoxides as the cationically polymerizable component results in cured compositions with high resistance to the impact of temperature or moisture.

In addition, due to the low viscosity and high formulation flexibility of the liquid composition its dosing properties can be adjusted over a wide range, thus making the compositions according to the present disclosure suitable in particular for the use in encapsulating applications.

As no halogen-containing flame retardants are used, the compositions can primarily be used for encapsulating applications in the electronics field. Thus, another object of the present disclosure is the use of the compositions for the encapsulation of electronic parts.

### DETAILED DESCRIPTION OF EXAMPLE EMBODIMENTS

In the following, the present disclosure will be described in detail and exemplarily by means of preferred embodiments, which, however, should not be construed as limiting.

In the sense of the present disclosure, “liquid” means that, at 23° C., the loss modulus G″ determined by measuring the viscosity is larger than the storage modulus G′ of the respective composition.

As far as the indefinite article “a” or “an” is used, this also comprises the plural form “one or more” unless this is explicitly excluded.

“At least difunctional” means that, per molecule, two or more units of the respective functional group named are contained.

“Solvent-free” means that no non-reactive solvents or diluents are added to the ready-for-use compositions.

Each weight proportion mentioned in the following relates to the total weight of the composition if not stated otherwise.

### Component (A): Cationically Polymerizable Component

With regard to their chemical basis, the cationically polymerizable components are not further restricted.

Preferably, the cationically polymerizable components are selected from the group consisting of epoxy-containing compounds (A1), oxetane-containing compounds (A2), vinyl ethers (A3) and combinations thereof. Optionally, the cationically polymerizable component can additionally contain one or more alcohols (A4) as chain transfer agents and/or cationically polymerizable hybrid compounds (A5). Moreover, the use of cyclic lactones or carbonates as the cationically polymerizable component is possible.

The epoxy-containing compound (A1) comprises aliphatic, aromatic and/or cycloaliphatic epoxy compounds.

Preferably, the epoxy-containing compound (A1) in the compositions according to the present disclosure comprises one or more at least difunctional epoxy-containing compounds. At least “difunctional” means that the epoxy-containing compound contains at least two epoxy groups

Preferably, the cationically polymerizable component (A) comprises at least one aromatic epoxy compound.

The group of aromatic epoxy compounds comprises, for example, bisphenol-A epoxy resins, bisphenol-F epoxy resins, phenol-novolac epoxy resins, cresol-novolac epoxy resins, biphenyl epoxy resins, 4,4′-biphenyl epoxy resins, divinylbenzene dioxide, 2-glycidyl phenyl ether, naphthalenediol diglycidyl ether, glycidyl ether of tris(hydroxyphenyl) methane, p-tert-butylphenol glycidyl ether and glycidyl ether of tris(hydroxyphenyl) ethane as well as mixtures thereof.

Moreover, all completely or partially hydrogenated analogues of aromatic epoxy compounds can be used as the epoxy-containing compound (A1).

The group of cycloaliphatic epoxy compounds comprises, for example, 2-cyclohexenylmethyl-3-cyclohexylcarboxylate diepoxide, 3,4-epoxycyclohexylalkyl-3′,4′-epoxycyclohexane carboxylate, 3,4-epoxy-6-methylcyclohexylmethyl-3′,4′-epoxy-6-methyl-cyclohexane carboxylate, vinyl cyclohexene dioxide, bis(3,4-epoxycyclohexylmethyl) adipate, dicyclopentadiene dioxide, dicyclopentadienyloxyethyl glycidyl ether, limonene dioxide and 1,2-epoxy-6-(2,3-epoxypropoxy)hexahydro-4,7-methane indane as well as mixtures thereof.

Isocyanurates substituted with epoxy-containing groups and other heterocyclic compounds can also be used as component (A1) in the compositions according to the present invention. Examples are triglycidyl isocyanurate and monoallyl diglycidyl isocyanurate.

In addition, polyfunctional epoxy resins of all compound classes mentioned, viscoelastic epoxy resins and mixtures of various epoxy compounds can be used in the compositions according to the present invention.

A combination of several epoxy-containing compounds at least one of which is preferably difunctional or of a higher functionality is also in the sense of the present disclosure.

In addition to the at least difunctional epoxy-containing compounds monofunctional epoxides can also be used as reactive diluents.

Examples of commercially available monofunctional epoxides are products sold under the tradenames Glycirol ED 509-S from Adeka, D.E.R. 727 from Olin, Heloxy Modifier AQ from Hexion, Cardolite Ultra Lite 513 by Cardolite or iPox RD 17 from iPox Chemicals GmbH.

Examples of further commercially available aliphatic epoxy compounds that are difunctional or of a higher functionality are products sold under the tradenames iPox RD21, iPox CL60, iPox CL9 from iPox Chemicals GmbH or YED-216D from Mitsubishi Chemical, Japan or Heloxy Modifier HD from Hexion or Araldite DY 3601 from Huntsman.

Examples of commercially available cycloaliphatic epoxy compounds are products sold under the tradenames CELLOXIDE™ 2021 P, CELLOXIDE™ 8000 from Daicel Corporation, Japan or Omnilane 1005, Omnilane 2005, Omnilane OC 3005 from IGM Resins B.V. or TTA21, TTA26 and TTA60 from Jiangsu Tetra New Material Technology Co. Ltd. or Syna Epoxy 21 from Synasia Inc.

Examples of commercially available aromatic epoxy compounds are products sold under the tradenames Epikote Resin 828 LVEL, Epikote Resin 166, Epikote Resin 169 from Hexion Specialty Chemicals B.V., Netherlands or EPICLON™ 840, 840-S, 850, 850-S, EXA850CRP, 850-LC from DIC K.K., Japan.

Epoxy compounds having basic groups which can inhibit cationic curing are not preferred. Preferably, the compositions are free of glycidyl amines.

Instead of or in addition to the epoxy-containing compound (A1) oxetane-containing compounds (A2) can be used in the compositions as a constituent of the cationically polymerizable component (A). Methods for producing oxetanes are particularly known from US 2017/0198093 A1.

Preferably, the cationically polymerizable component (A) comprises at least one oxetane-containing compound (A2). In particular low-viscosity oxetanes allow the advantageous use of the composition according to the present disclosure as an encapsulating material.

Examples of commercially available oxetanes (A2) are bis(1-ethyl-3-oxetanylmethyl) ether (DOX), 3-allyloxymethyl-3-ethyl oxetanes (AQX), 3-ethyl-3-[(phenoxy) methyl oxetanes (POX), 3-ethyl-3-hydroxymethyl oxetanes (OXA), 1,4-bis[(3-ethyl-3-oxetanylmethoxy)methyl]benzene (XDO), 3-ethyl-3-[(2-ethylhexyloxy)methyl]oxetane (EHOX). The oxetanes mentioned are commercially available from TOAGOSEI CO., Ltd.

In addition to component (A1) and optionally to component (A2), vinyl ethers (A3) can be used as cationically polymerizable components in the compositions. Suitable vinyl ethers are trimethylolpropane trivinyl ethers, ethylene glycol divinyl ethers and cyclic vinyl ethers as well as mixtures thereof. Moreover, vinyl ethers of polyfunctional alcohols can be used.

In addition, the cationically polymerizable component can also comprise one or more alcohols (A4) that are used as chain transfer agents. In particular polyols of higher molecular weight can be used to flexibilize cationic compositions. For example, suitable polyols are available based on polyethers, polyesters, polycaprolactones, polycarbonates, polybutadiene diols or hydrogenated polybutadiene diols.

Examples of commercially available polyols of higher molecular weight are products available under the tradenames ETERNACOLL UM-90 (1/1), Eternacoll UHC50-200 from UBE Industries Ltd., Capa™ 2200, Capa™ 3091 from Perstorp, Liquiflex H from Petroflex, Merginol 901 from HOBUM Oleochemicals, Placcel 305, Placcel CD 205 PL from Daicel Corporation, Priplast 3172, Priplast 3196 from Croda, Kuraray Polyol F-3010, Kuraray Polyol P-6010 from Kuraray Co., Ltd., Krasol LBH-2000, Krasol HLBH-P3000 from Cray Valley or Hoopol S-1015-35 or Hoopol S-1063-35 from Synthesia Internacional SLU.

Finally, in addition to components (A1) to (A4), hybrid compounds (A5) can be used as well. Apart from at least one of the cationically polymerizable groups mentioned they also contain radically polymerizable groups. In particular epoxy (meth)acrylate hybrid compounds are in the sense of the invention. Examples of commercially available epoxy (meth)acrylates are CYCLOMER M100 from Daicel, Epoxy Acrylat Solmer SE 1605, UVACURE 1561 from UCB, Miramer PE210HA from Miwon Europe GmbH and Solmer PSE 1924 from Soltech Ltd. Oxetane (meth)acrylates such as Eternacoll OXMA from UBE Industries LTD can also be used as a hybrid compound (A5).

The list of the cationically polymerizable components (A) is to be considered as exemplary and non-final. A mixture of the cationically polymerizable components (A1) to (A5) mentioned is also in the sense of the present disclosure.

More preferably, the selection of components (A1) to (A5) is such that they have a halogen content that is as low as possible, and are preferably halogen-free.

Instead of or in addition to the components (A1) to (A5) mentioned the use of resin components already carrying flame retardant groups is also possible. For example, phosphorus-containing epoxy resins (A1) such as Exolit EP 360 or Exolit EP 390 from Clariant can be used.

Moreover, for example phosphorus-containing polyols such as Exolit OP 550 or Exolit OP 560 available from Clariant or DAIGUARD-610 available from Daihachi Chemical Industry Co. Ltd. can be used as components (A4).

Instead of or in addition to phosphorus-containing resin components epoxy-functional siloxanes or silicones can also be used in component (A). They also exhibit an intrinsically flame-retardant effect. Suitable examples are 2,4-di[2-(3-{oxabicyclo[4.1.0]heptyl})ethyl]-2,4,6,6,8,8-hexamethyl cyclotetrasiloxane, 4,8-di[2-(3-(oxabicyclo[4.1.0]heptyl})ethyl]-2,2,4,6,6,8-hexamethyl cyclotetrasiloxane, 2,4-di[2-(3-{oxabicyclo[4.1.0]heptyl})ethyl]-6,8-dipropyl-2,4,6,8-tetramethyl cyclotetrasiloxane, 4,8-di[2-(3-{oxabicyclo[4.1.0]heptyl})ethyl]-2,6-dipropyl-2,4,6,8-tetramethyl cyclotetrasiloxane, 2,4,8-tri[2-(3-{oxabicyclo[4.1.0]heptyl})ethyl]-2,4,6,6,8-pentamethyl cyclotetrasiloxane, 2,4,8-tri[2-(3-{oxabicyclo[4.1.0]heptyl})ethyl]-6-propyl-2,4,6,8-tetramethyl cyclotetrasiloxane or 2,4,6,8-tetra[2-(3-{oxabicyclo[4.1.0]heptyl})ethyl]-2,4,6,8-tetramethyl cyclotetrasiloxane. Further suitable cycloaliphatic epoxy-functional silicone resins can be found in JP 2008 248 169 A. Suitable epoxy-functional organopolysilsesquioxanes are described in JP 2008 019 422 A.

Suitable commercially available examples are ALBIFLEX 246 or ALBIFLEX 296 from Evonik Industries; Polyset PC-1000 or PC-2000 from Polyset and EP0408 or EP0409 from Hybridplastics.

The proportion of the required flame retardant (C) and/or the filler (D) can be reduced by using intrinsically flame retardant resin components.

In the composition according to the present disclosure, the cationically polymerizable component (A) is present, according to the present disclosure, in a proportion of 15 to 80% by weight, preferably in a proportion of 20 to 75% by weight, based on the total weight of the composition.

According to one embodiment the cationically polymerizable component (A) contains at least one aromatic epoxy compound (A1).

According to another embodiment the cationically polymerizable component (A) is selected from the group of epoxy-containing compounds (A1) and oxetane-containing compounds (A2) as well as combinations thereof.

Preferably, the cationically polymerizable component (A) comprises an epoxy-containing compound (A1) and additionally an oxetane-containing compound (A2).

The oxetane-containing compound (A2) is preferably present in a proportion of 1 to 50% by weight, particularly preferably in a proportion of 3 to 30% by weight, each based on the total weight of the composition. The ratio of compound (A1) to (A2) is preferably from 1:2 to 5:1.

### Component (B): Initiators for Cationic Polymerization

Apart from component (A), the compositions according to the present disclosure contain at least one initiator (B) for cationic polymerization comprising an acid generator that can be activated by heat and/or actinic radiation. In the following, the initiators are also described as “photolatent acids” or “heat-latent” acids. Suitable initiators are, for example, metallocenium-based acid generators and/or onium compounds.

EP 0 542 716 B1 discloses an overview of various metallocenium salts. Examples of different anions of metallocenium salts are HSO₄⁻, PF₆⁻, SbF₆⁻, AsF₆⁻, Cl⁻, Br⁻, I⁻, ClO₄⁻, PO₄⁻, SO₃CF₃⁻, OTs⁻ (tosylate), aluminate and borate anions such as BF₄⁻ and B(C₆F₅)₄⁻.

Preferred metallocenium compounds are selected from the group of ferrocenium salts.

Preferred onium compounds are selected from the group of arylsulfonium salts and aryliodonium salts and combinations thereof, and described in the state of the art.

Triarylsulfonium-based photoinitiators (B1) commercially available as photolatent acids are available under the tradenames Chivacure 1176, Chivacure 1190 from Chitech, Irgacure 290, Irgacure 270, Irgacure GSID 26-1 from BASF, Speedcure 976 and Speedcure 992 from Lambson, TTA UV-692, TTA UV-694 from Jiangsu Tetra New Material Technology Co., Ltd. or UVI-6976 and UVI-6974 from Dow Chemical Co.

Diarylsulfonium-based photoinitiators (B1) commercially available as photolatent acids are, for example, available under the tradenames UV1240, UV1242 or UV2257 from Deuteron and Bluesil 2074 from Bluestar.

The photoinitiators (B1) used in the compositions according to the present disclosure are preferably activatable by irradiation with actinic radiation of a wavelength of 200 to 480 nm, more preferably at a wavelength of 250 to 365 nm.

According to the present disclosure, a mixture of photoinitiators (B1) which can be activated at different excitation wavelengths can also be used. A mixture of photoinitiators based on metallocenium, preferably ferrocenium, and onium compounds, preferably sulfonium compounds, is preferred. The metallocenium-based photoinitiators can have an excitation wavelength of about 400 to 700 nm, preferably 430 to 500 nm. The excitation wavelength of the onium compounds used as photoinitiators is about 200 to 380 nm, preferably 300 to 380 nm.

When needed, the photoinitiator (B1) can be combined with a suitable sensitizer.

In addition to or instead of the photoinitiator (B1) the compositions according to the present disclosure can also contain a thermally activatable initiator (B2) for cationic polymerization. For example, quaternary N-benzylpyridinium salts and N-benzylammonium salts as disclosed in EP 0 343 690 A or WO 2005/097883 A are suitable as such heat-latent acids. Apart from that, thermally activatable sulfonium salts as described in WO 2019/043778 A1 can also be used as acidifiers.

Commercially available products are available under the designations K-PURE CXC-1614, K-PURE CXC-1821 or K-PURE CXC-1733 from King Industries Inc.; SAN-AID SI-80L and SAN-AID SI-100L from SAN-SHIN Chemical Industry Co. Ltd.

In addition, various metal chelate complexes based on titanium or aluminum can be used as heat-latent acids. Such initiators are described in EP 3 300 504 B1.

Initiators (B1) and (B2) can be contained in the present compositions in proportions of 0.001 to 5% by weight, preferably 0.01 to 3% by weight and particularly preferably 0.1 to 2% by weight each, based on the total weight of the composition.

### Component (C): Flame Retardant

The compositions according to the present disclosure contain at least one flame retardant (C) comprising at least one organophosphinate (C1). Optionally, another flame retardant (C2) based on phosphorus can be contained.

The use of additional halogen-free flame retardants containing no phosphorus (C3) is also possible.

Suitable examples of the flame retardant (C1) are organophosphinates based on aluminum or zinc salts. Organosphosphorus compounds derived from alkyl or aryl phosphinic acids are particularly suitable. They are, for example, available from Clariant under the tradenames Exolit OP 930, OP 935, OP 945, OP 950 or OP 1230.

Aluminum diethylphosphinates (ADEP) available under the designation OP 935 are particularly suitable for use as flame retardant (C1) in the present compositions.

In the compositions according to the present disclosure the flame retardant (C1) is typically present as a solid. The proportion of the organophosphinate (C1) is at least 10% by weight, preferably at least 15% by weight and more preferably at least 20% by weight, each based on the total weight of the composition.

According to one embodiment the flame retardant (C) comprises an additional flame retardant (C2) based on phosphorus. The additional phosphorus-based flame retardant (C2) is preferably selected from the group of phosphate esters and has a molar mass of less than 5.000 g/mol, preferably less than 1.500 g/mol.

The mass fraction of phosphorus atoms, based on the total weight of the composition, is at least 2%, preferably at least 2.5% and particularly preferably at least 3%.

Examples of respective phosphate esters are bisphenol-A-bis(diphenylphosphate), triphenylphosphate, resorcinbis(diphenylphosphate), resorcinbis(2,6-xylenylphosphate) 4,4′-biphenolbis(diphenylphosphate) and further homologues of oligomeric bisphenol-A phosphate esters.

They are commercially available from Adeka under the tradenames ADK STAB FP-600, ADK STAB PFR, ADK STAB FP-900L, ADK STAB FP-2100JC, ADK STAB FP-2500S, ADK STAB FP-2600U and from Nordmann, Rassmann GmbH under the designation NORD-MIN BDP.

In the compositions, in particular aromatic phosphate esters can be advantageously combined with the flame retardant. Apart from phosphate esters, phosphates such as ammonium polyphosphate can be advantageously used as component (C2) in the compositions.

In the compositions according to the present disclosure the additional flame retardant (C2) is typically present in the liquid form. The proportion of the additional flame retardant (C2) is preferably 0 to 40% by weight, more preferably 1 to 30% by weight and even more preferably 5 to 20% by weight.

If the additional flame retardant (C2) is added in the compositions according to the present disclosure, the amount of component (C1) used can be reduced while achieving flame retardancy, preferably pursuant to the UL94 V0 standard.

The weight ratio between components (C1) and (C2) is from 10:1 to 1:3, preferably from 8:1 to 1:2, more preferably from 5:1 to 2:3.

For example, borates such as zinc borate (ZnBO₄), zinc stannates such as Flamtard HF (ZnSn(OH)₆), antimony oxides (Sb₂O3, Sb₂O5) and melamine cyanurates can be optionally used as additional flame retardants or flame protection synergists (C3) containing no phosphorus.

In the compositions according to the present disclosure the flame retardant containing no phosphorus (C3) can be contained in addition to components (C1) und (C2) in a proportion of up to 10% by weight, preferably up to 5% by weight.

All flame retardants used in the compositions according to the present disclosure are preferably halogen-free.

### Component (D): Filler

The compositions according to the present disclosure optionally contain at least one solid filler (D) that, apart from the flame retardant properties of the cured composition, also affects chemical resistance, media absorption and the thermal expansion coefficient. However, the filler (D) does not affect the flame retardancy properties of the compositions according to the present disclosure by a chemical or physical mechanism but reduces the proportion of combustible organic constituents, based on the total weight of the formulation, when added. Thus, the filler (D) can also positively affect the flame retardancy properties of the cured composition. Depending on the property profile required and the intended use of the compositions according to the present disclosure different fillers or combinations thereof can be used.

To achieve a low thermal expansion coefficient, usually quartz or fused silica is used as a filler. To this end, materials with a negative thermal expansion coefficient (such as zirconium tungstate) can be used.

To achieve higher thermal conductivity, fillers such as aluminum oxide, aluminum nitride, boron nitride, graphite (also expanded graphite or graphite-based nanotechnology products), graphene, carbon nanotubes or metal fillers can be used.

To achieve an isotropic or anisotropic electrical conductivity, metal fillers or non-metal fillers coated with electrically conductive layers can be used.

To achieve defined adhesive thicknesses, so-called “spacer particles” with narrowly defined particle shapes and particle size distributions can be used as a filler.

The selection of fillers in terms of particle shapes (for example angular, spherical, platelet- or needle-shaped, hollow) and particle sizes (macroscopic, microscopic, nano-scale) is in no way restricted. Various particle shapes or particle sizes or particle size distributions are known to be used in combination to achieve, for example, low viscosity, a higher maximum filling level or high electrical and thermal conductivity.

Preferably, the filler (D) is selected from the following group: oxides, nitrides, borides, carbides, sulfides and silicides of metals and metalloids, including mixed compounds of several metals and/or metalloids; carbon modifiers such as diamond, graphite and carbon nanotubes; silicates and borates of metals and metalloids; all types of glasses; metals and metalloids in their elementary form or in the form of alloys or intermetal phases, and particles made of polymeric materials such as silicone, polyamide and PTFE.

The use of mixtures of different fillers (D) is also in the sense of the present disclosure.

In the compositions according to the present disclosure the filler (D) is present in a proportion of 0 to 60% by weight, preferably 5 to 50% by weight, more preferably 15 to 40% by weight, each based on the total weight of the composition.

The total amount of solids in the composition containing components (A) to (D) and optionally further additives (E) is at most 70% by weigh, preferably at most 65% by weight.

In particular with a solids content of the composition of 70% by weight or more, flowability of the composition is reduced so drastically that the dosing and suitability for use as an encapsulating composition is restricted. The proportion of the filler (D) is thus restricted to a maximum of 60% by weight, and is further adjusted depending on the proportion of the solid flame retardant (C) and optionally further solid additives (E).

Preferably, spherical fillers are used to keep the viscosity of the liquid composition low and ensure its suitability as an encapsulating composition.

In particular with proportions of 20% by weight or more of an unreactive filler, smaller amounts of the flame retardants (C) can be used while achieving flame retardancy according to the UL94 V-0 standard.

### Component (E): Additives

In addition, the described compositions can also contain optional constituents as additives (E).

The additives (E) are preferably selected from the group consisting of dyes, pigments anti-ageing agents, fluorescent agents, sensitizers, accelerators, stabilizers, adhesion promoters, desiccants, crosslinkers, flow improvers, wetting agents, thixotropic agents, non-reactive flexibilizers, non-reactive polymeric thickeners, corrosion inhibitors, plasticizers and combinations thereof.

In the compositions according to the present disclosure the additives (E) are particularly present in a proportion of up to 20% by weight, based on the total weight of the composition.

Apart from components (A) to (D), the compositions according to the present disclosure preferably contain a stabilizer as an additive (E) ensuring sufficiently high latency at room temperature and allowing the processing time of the compositions to be set.

Possible stabilizers are quaternary ammonium salts, hydroxyl amines, cyclic amides, imidazoles, nitriles, hydroquinones, organic phosphites and phosphates, pyridines, crown ethers, copper salts, cyclic imines, sulfoniumalkyl sulfonates, thioethers or isocyanurates. Specific examples can be found in U.S. Pat. Nos. 5,453,450 A, 5,362,421 A, 5,296,567 A, 5,374,697 A, JP 2015 025 082 A, KR 891 414 B1, US 2019/0225740 A1, US 2020/0190251 A1 or JP 2005 120 190 A.

Preferred commercially available stabilizers comprise (4-hydroxyphenyl)dimethylsulfonium methylsulfate, available under the tradenames SAN-AID SI-S from San-Shin Chemical Industry Co. Ltd. and 4-(methylthio)phenol.

If hybrid compounds (A5) are used which, apart from a cationically polymerizable group, also comprise a radically polymerizable group, the compositions according to the present disclosure can additionally contain a radical generator as an initiator for radical polymerization as a further additive (E). Suitable radical initiators are, for example, peroxides and/or radical photoinitiators.

Formulation of the compositions according to the present disclosure

A formulation of the compositions according to the present disclosure comprises at least components (A) to (C). In addition, fillers (D) and further additives (E) can be contained.

In a first embodiment the composition comprises or consists of the following components:
(A) at least one cationically polymerizable component (A);
(B) at least one initiator for cationic polymerization, preferably in a proportion of 0.001 to 5% by weight;
(C) at least 10% by weight of an organophosphinate (C1) as a flame retardant, and optionally additional flame retardants (C2) based on phosphorus;
(D) 0 to 60% by weight of a filler; and
(E) optionally further additives,
with the solids content from components (C), (D) and optionally (E) being at most 70% by weight, preferably at most 65% by weight, based on the total weight of the composition.

The cationically polymerizable component (A) is present in a proportion of 15 to 80% by weight, particularly preferably in a proportion of 20 to 75% by weight.

Furthermore, the cationically polymerizable component (A) preferably contains at least one aromatic epoxy resin (A1). The use of aromatic epoxy resins has a favorable effect on the flame retardant properties of the cured compositions.

In the composition according to the present disclosure the organophosphinate (C1) is preferably present in a proportion of 10 to 30% by weight, preferably at least 15% by weight and more preferably at least 20% by weight. For flow property reasons, proportions of more than 30% by weight or 25% by weight are not useful.

The proportion of fillers (D) is preferably 5 to 50% by weight.

If the composition does not contain a filler (D) or the proportion of the filler (D) is not more than 10% by weight, preferably at least 20% by weight of the organophosphinate is used.

In a second embodiment the composition comprises or consists of the following components, each based on the total weight of the composition:
(A) at least one cationically polymerizable component (A) in a proportion of 15 to 80% by weight comprising at least one aromatic epoxy compound (A1) and one oxetane-containing compound (A2);
(B) an initiator for cationic polymerization, preferably in a proportion of 0.001 to 5% by weight;
(C) at least 10% by weight of an organophosphinate (C1) as a flame retardant, and optionally additional flame retardants (C2) based on phosphorus;
(D) 0 to 60% by weight of a filler, preferably 5 to 50% by weight; and
(E) optionally further additives.

Due to the use of low-viscosity oxetane-containing compounds as component (A) the second embodiment of the composition according to the present disclosure is particularly suitable for encapsulating applications, preferably for the encapsulating of electronic parts.

In addition, sufficient flame retardancy can be achieved in the second embodiment even at low proportions of the filler (D) by adding an additional liquid flame retardant (C2) based on phosphorus. Therefore, compositions of lower viscosity can be obtained without the reactivity or flame retardant effect being reduced.

With respect to the proportions of the flame retardants (C) and the filler (D) reference is made to the explanations given for the first embodiment.

In a third embodiment the composition is pre-activatable by irradiation with actinic radiation and comprises or consists of the following components:
(A) at least one cationically polymerizable component (A) in a proportion of 15 to 80% by weight;
(B) 0.01 to 3% by weight of a photoinitiator for cationic polymerization based on metallocenium, preferably ferrocenium, and, optionally, 0.01 to 3% by weight of another initiator for cationic polymerization, preferably a photoinitiator based on an onium compound, preferably a sulfonium compound;
(C) at least 10% by weight of an organophosphinate (C1) as a flame retardant, and optionally additional flame retardants (C2) based on phosphorus;
(D) 0 to 60% by weight of a filler, preferably 5 to 50% by weight; and
(E) optionally further additives.

The composition of the third embodiment contains at least one initiator based on metallocenium, preferably ferrocenium. Metallocenium-based initiators impart a longer open time to the composition and are thus well suited for pre-activatable systems.

In a variant of the third embodiment a mixture of photoinitiators (B1) which can be activated at different excitation wavelengths can be advantageously used. A mixture of photoinitiators based on metallocenium, preferably ferrocenium, and onium compounds, preferably sulfonium compounds, is preferred. The metallocenium-based photoinitiators can have an excitation wavelength in the range of about 400 to 700 nm, preferably 430 to 500 nm. The excitation wavelength of the onium compounds used as photoinitiators is about 200 to 380 nm, preferably 300 to 380 nm.

The composition according to the third embodiment can be pre-activated by irradiation at a wavelength of about 200 nm or more, preferably directly in a flow device. After applying the pre-activated composition onto a substrate, it is cured within 7 days at room temperature without any additional energy input. Curing can be accelerated by heat.

If the composition contains a mixture of metallocenium-based photoinitiators and additional photoinitiators, a first irradiation at the excitation wavelength of the metallocenium-based photoinitiator, preferably at about 400 to 700 nm, is performed for pre-activation. After applying the pre-activated composition onto a substrate, the composition is again irradiated at an excitation wavelength of the additional photoinitiator of preferably 200 to 380 nm. Thus, in a pre-activated composition containing a mixture of photoinitiators, fast fixing of the composition by irradiation with actinic radiation at the excitation wavelength of the additional photoinitiator after its application onto a substrate can be achieved. For final curing, either sufficient waiting time can be observed or the compositions can be additionally heated

With respect to the proportions of the flame retardants (C) and the filler (D) reference is made to the explanations given for the first embodiment.

All compositions according to the described embodiments achieve flame retardancy, preferably according to the UL94 V-0 standard, but at least according to the UL94 V-1 standard.

Properties of the compositions according to the present disclosure:

The compositions according to the present disclosure are characterized by being highly reactive during cationic polymerization while showing high flame retardancy in the cured state. The obtained flame retardancy preferably corresponds to the UL94 V-0 standard and thus the high demands as are, for example, required in the automotive and aviation industry.

Many of the flame retardants known in the state of the art tend to slow down or completely stop cationically induced curing due to their alkalinity and/or inhibitory effect. Surprisingly, due to the selection of the flame retardants (C) according to the present disclosure, compositions can be formulated which, despite a high degree of flame retardancy, still exhibit an unchangedly high reactivity as compared to compositions without flame retardancy. Due to the high reactivity high curable layer thicknesses of at least 1 mm, preferably 2 mm, particularly preferably 3 mm, can be achieved during photocuring.

As the flame retardants used do not or only slightly inhibit curing of the compositions, the compositions are highly reactive. Thus, the mechanical properties of the cured compositions can be reliably set by selecting the cationically polymerizable component (A). The elastic modulus of the cured compositions can have a wide range of 10 to 20,000 MPa at room temperature.

The cured compositions have a glass transition temperature between −40° C. and 200° C.

In addition, due to the low viscosity and high formulation flexibility of the liquid composition its dosing properties can be set over a wide range, thus making the compositions according to the present disclosure particularly suitable for use in encapsulating applications. The liquid compositions have an excellent viscosity of less than 100,000 mPa*s, preferably less than 75,000 mPa*s and particularly preferably less than 60,000 mPa*s.

Due to not using halogen-containing flame retardants the compositions can primarily be used for encapsulating applications in the electronics field. At the same time, the use of epoxides as a cationically polymerizable component results in cured compositions with high resistance to the impact of temperature or moisture.

The formulations according to the present disclosure preferably contain less than 900 mg/kg of bromine or chlorine and, at large (bromine+chlorine), less than 1.500 mg/kg of both elements, each based on the total weight of the composition. Such compositions are considered as “halogen-free” according to the DIN EN 61249-2-21 standard.

Method using the compositions according to the present disclosure

According to the present disclosure, the cationically polymerizable composition is used in a method for joining, encapsulating or coating substrates, the method comprising the following steps:
a) providing the composition according to the present disclosure;
b) dosing the composition onto a first substrate;
c) optionally supplying a second substrate to the composition; and
d) fixing and/or curing the composition by irradiation with actinic radiation;
e) optionally heating the composition and the substrate and/or the substrate composite.

In a variant of the described method in which the compositions exclusively contain a thermally activatable initiator (B2), the method comprises steps a) to c) and e).

In another embodiment of the method the compositions can be activated in a so-called flow device. Suitable dosing devices for flow activation of the compositions by irradiation are described in DE 3 702 999 A and DE 10 2007 017 842 A.

When using a flow device, the composition can be irradiated prior to the dosing step b). Thus, the activation of the composition can be performed separately, in terms of time and space, from dosing onto the first substrate.

DE 43 40 949 A1 and WO 2020 120 144 A1 disclose suitable initiator systems for cationic polymerization based on photolatent acids. They are incorporated into the present disclosure by reference.

By using a second photoinitiator for cationic polymerization which, at an excitation wavelength that is different from that of the first initiator, releases an acid, the composition can be additionally fixed after dosing onto the first substrate by irradiation with actinic radiation and transferred into a dimensionally stable and flow-stable state.

A method for joining, encapsulating or coating substrates using a flow device comprises the following steps:
a) providing the composition according to the present disclosure;
b) activating the composition by actinic radiation in a flow device;
c) dosing the composition onto a first substrate;
d) optionally supplying a second substrate to the composition; and
e) optionally fixing and/or curing the composition by irradiation with actinic radiation;
f) heating the composition and the substrate and/or the substrate composite.

In particular the compositions of the third embodiment are suitable for use in a flow device according to the method described herein.

By using the compositions according to the present disclosure articles can be obtained which, after curing of the composition, exhibit a flame retardancy according to the fire protection class UL94 V-0.

### Measuring Methods Used and Definitions

### Irradiation

For irradiation, the compositions according to the present disclosure were irradiated with LED lamps of the DELOLUX series from DELO Industrie Klebstoffe GmbH & Co. KGaA with a wavelength of 365 nm or 460 nm at an intensity of 200±20 mW/cm².

### Room Temperature

Room temperature is defined as 23±2° C.

### Determination of Viscosity

Viscosity was measured with a Physica MCR302 rheometer from Anton Paar with a standardized PP20 measuring cone at 23° C. with a 500 μm slot, and determined at a shear rate of 10 s⁻¹.

### Fire Test Following UL94 V-0

Fire classification was tested on the basis of the Underwriters Laboratories standard “UL94: Tests for Flammability of Plastic Materials for Parts in Devices and Appliances”.

A metal plate (thickness 3 mm) having a recession of a length of 125 mm and a width of 13 mm is used as a mold for the production of specimens. The mold is placed on a plastic foil (PET) translucent for actinic radiation as a temporary carrier, filled with the curable composition without bubble formation and provided with another cover foil. Fixation of the composition by light is performed by bilateral sequential irradiation (60 s for each side, turning after the first 60 s). Subsequent heat curing is performed for 30 min in a pre-heated convection oven at 130° C. After cooling of the specimen mold the rod-shaped specimen made of the cured composition is demolded and conditioned for 48 hours at room temperature.

The flame used for the fire tests is provided by a Bunsen burner having an output of 50 Watts. The after-flame times measured are to be understood as the burning period after each flame treatment.

For the vertical fire test, a flame is positioned under the test specimen for 10 s and then the after-flame time t1 is stopped. The flame is again positioned under the test specimen for 10 s and the after-flame time t2 us stopped.

| Fire classification | −V0 | −V1 | −V2 |
|---|---|---|---|
| Burning period after | ≤10 s | ≤30 s | ≤30 s |
| each flame treatment | | | |
| Sum of all after-flame times | ≤50 s | ≤250 s | ≤250 s |
| After-flame time after | ≤30 s | ≤60 s | ≤60 s |
| second flame treatment | | | |
| Complete burning | No | No | No |
| Combustible drips | No | No | Yes |

Fire classification is evaluated corresponding to the above table, with the respective fire classification achieved only when achieving all parameters mentioned.

The fire test was repeated using four further test specimens prepared analogously, with the “sum of all after-flame times” relating to the sum of t1 and t2 of all five test specimens.

For the system of example 10 the first irradiation was performed with a wavelength of 460 nm for 30 s using a DELOLUX 20/460 LED lamp at an intensity of 200 mW/cm². Then, the test specimen was irradiated bilaterally with the second wavelength for 30 s on each side using a DELOLUX20/365 LED lamp at an intensity of 200 mW/cm². Subsequently, the test specimen was cured for 60 min. at 80° C. in an oven.

### Thermal DSC Measurements

DSC measurements of the reactivity are performed with a differential scanning calorimeter (DSC) of the DSC2 or DSC3+ type from Mettler Toledo.

To this end, 6 to 10 mg of the liquid sample are weighted into an aluminum crucible (40 μL), tightly sealed with a lid and measured at a heating rate of 5 K/min at 30 to 230° C. The processing gas is air (volume flow 30 mL/min).

Onset, enthalpy and peak temperature are evaluated.

### Photo DSC Measurements

DSC measurements of the reactivity of radiation-induced curing are performed with a differential scanning calorimeter (DSC) of the DSC2 or DSC3+ type from Mettler Toledo. To this end, 6 to 10 mg of the liquid sample are weighted into an aluminum crucible (40 μL) with a pin and irradiated with 365 nm for 10 min at 30° C.

After subtracting the energy input caused by the LED lamp peak time and enthalpy are evaluated.

### Manufacture of the Curable Compositions

First, the liquid constituents are mixed and then the fillers (D) and flame retardants (C), optionally additional solids, are incorporated by means of a laboratory agitator, laboratory dissolver or speed mixer (company Hauschild) until a homogeneous composition is formed. Compositions which contain photoinitiators and are sensitive to visible light have to be manufactured under light of a different excitation wavelength than that of the photoinitiators or sensitizers.

The so produced compositions were filled in single-chamber cartridges and sealed.

All compounds used for the production of the curable compositions, and their abbreviations are stated in the following list:

### Component (A): Cationically Polymerizable Component

(A1-1) 3,4-epoxycyclohexylmethyl-3′,4′-epoxycyclohexane carboxylate, available under the tradename Celloxide 202 P from Daicel;
(A1-2) Epikote™ Resin 169 (mixture of bisphenol-A and bisphenol-F glycidyl ethers), available from Hexion;
(A1-3) jER YL980=bisphenol-A epoxy resin, available from Mitsubishi Chemical
(A2-1) OXT-221=bis[1-ethyl(3-oxetanyl)]methyl ether, available from Toagosei.

### Component (B): Initiator

(B1-1) Chivacure 1176=diphenyl(4-phenylthio)phenylsulfonium hexafluoroantimonate and (thiodi-4,1-phenylene)bis(diphenylsulfonium) dihexafluoroantimonate, 50% in propylene carbonate, available from Chitec (photoinitiator);
(B1-2) R-Gen 262=(η⁵-2,4-cyclopentadiene-1-yl)[(1,2,3,4,5,6-η)-(1-methylethyl)benzene]-iron(1) hexafluoroantimonate, available from Chitec (photoinitiator), 50% in propylene carbonate;
(B2-1) K-Pure CXC-1733 quaternary benzylammonium salt, available from King Industries (heat-latent acid), 50% in propylene carbonate.

### Component (C): Flame Retardant

(C1-1) Aluminum diethylphosphinate, available under the tradename Exolit OP 935 from Clariant;
(C2-1) NORD-MIN BDP=aromatic phosphate ester, available from Nordmann, Rassmann GmbH;
(C4) Exolit EP 150 (diethyl phosphinic acid), available from Clariant (comparison).

### Component (D): Inorganic Filler

(D1) Fused Silica FB-74X, available from Denki Kagaku Kōgyō K.K.;
(D2) Fused Silica FB-7SDX, available from Denki Kagaku Kōgyō K.K.;
(D3) Fused Silica SFP-30M, available from Denki Kagaku Kōgyō K.K.;
(D4) Spherical Alumina DAW-05, available from Denki Kagaku Kōgyō K.K.;
(D5) Spherical Alumina DAW-03DC, available from Denki Kagaku Kōgyō K.K.;
(D6) Spherical Alumina ASFP-20, available from Denki Kagaku Kōgyō K.K.

### Component (E): Additives

(E-1) HDK H 2000 fumed silica, available from Wacker (thixotropic agent);
(E-2) Dynasylan Glymo, available from Evonik (adhesion promoter);
(E-3) (4-hydroxyphenyl)dimethylsulfonium methylsulfate, available under the tradename SAN-AID SI-S from San-Shin Chemical Industry Co. Ltd (stabilizer).

In all examples and comparative samples less than 1% by weight (E-1), 0.5% by weight (E-2) and 0.2% by weight (E-3) are contained.

| | Examples according to the present invention | | | | | | | | | |
|---|---|---|---|---|---|---|---|---|---|---|
| Example no. | 1 | 2 | 3 | 4 | 5 | 6 | 7 | 8 | 9 | 10 |

Component (A): cationically polymerizable components [% by weight]

| | | | | | | | | | | |
|---|---|---|---|---|---|---|---|---|---|---|
| (A1-1) | 17.0 | 14.8 | 8.1 | 11.4 | 13.7 | 8.2 | 8.7 | 8.2 | 8.2 | 8.3 |
| (A1-2) | 58.8 | 51.0 | 27.7 | 39.4 | 47.1 | | 29.9 | | | |
| (A1-3) | | | | | | 5.8 | | 5.8 | 5.8 | 5.9 |
| (A2-1) | | | | | | 11.8 | | 11.8 | 11.8 | 12.1 |

Component (B): initiator for cationic polymerization [% by weight]

| | | | | | | | | | | |
|---|---|---|---|---|---|---|---|---|---|---|
| (B1-1) | 1.0 | 1.0 | 1.0 | 1.0 | 1.0 | 1.0 | 1.0 | 2.5 | | 1.5 |
| (B1-2) | | | | | | | | | | 0.5 |
| (B2-1) | 1.5 | 1.5 | 1.5 | 1.5 | 1.5 | 1.5 | 1.5 | | 2.5 | |

Component (C): flame retardant [% by weight]

| | | | | | | | | | | |
|---|---|---|---|---|---|---|---|---|---|---|
| (C1-1) | 20.0 | 20.0 | 20.0 | 10.0 | 10.0 | 10.0 | 10.0 | 10.0 | 10.0 | 10.0 |
| (C2-1) | 0 | 0 | 0 | 5.0 | 15.0 | 10.0 | 5.0 | 10.0 | 10.0 | 10.0 |
| (C4) | | | | | | | | | | |
| (C1):(C2) ratio | | | | 2:1 | 2:3 | 1:1 | 2:1 | 1:1 | 1:1 | 1:1 |

Component (D): filler [% by weight]

| | | | | | | | | | | |
|---|---|---|---|---|---|---|---|---|---|---|
| (D1) | 0 | 8.7 | 34.6 | 26.0 | 8.7 | 43.3 | | 43.3 | 43.3 | 43.3 |
| (D2) | 0 | 1.2 | 4.8 | 3.6 | 1.2 | 6.0 | | 6.0 | 6.0 | 6.0 |
| (D3) | 0 | 0.1 | 0.6 | 0.4 | 0.1 | 0.7 | | 0.7 | 0.7 | 0.7 |
| (D4) | | | | | | | 36.5 | | | |
| (D5) | | | | | | | 5.1 | | | |
| (D6) | | | | | | | 0.6 | | | |

Component (E): additives [% by weight]

| | | | | | | | | | |
|---|---|---|---|---|---|---|---|---|---|
| 1.7 | 1.7 | 1.7 | 1.7 | 1.7 | 1.7 | 1.7 | 1.7 | 1.7 | 1.7 |

Properties of the compositions

| | | | | | | | | | | |
|---|---|---|---|---|---|---|---|---|---|---|
| Viscosity | 5086 | 6599 | 54959 | 7874 | 4855 | 7748 | 10997 | 8507 | 9044 | 7994 |
| 10 · 1/s | | | | | | | | | | |
| [mPa*s] | | | | | | | | | | |
| Fire protection | V-0 | V-0 | V-0 | V-0 | V-0 | V-0 | V-0 | V-0 | V-0 | V-0 |
| class | | | | | | | | | | |
| Solids content | 21 | 31 | 61 | 41 | 21 | 61 | 51 | 61 | 61 | 61 |
| [% by weight] | | | | | | | | | | |
| DSC onset | 96 | 95 | 97 | 94 | 95 | 91 | 97 | — | 86 | — |
| [° C.] | | | | | | | | | | |
| Phosphorus content | 4.74 | 4.74 | 4.74 | 2.82 | 3.71 | 3.26 | 2.82 | 3.26 | 3.26 | 3.26 |
| [% by weight] | | | | | | | | | | |

| | Comparative examples | | | |
|---|---|---|---|---|
| Example no. | 11 | 12 | 13 | 14 |
| Component (A): cationically polymerizable components [% by weight] | | | | |
| (A1-1) | 5.8 | 6.9 | 8.1 | 17.0 |
| (A1-2) | 20.0 | 23.9. | 27.7 | 58.8 |
| (A1-3) | | | | |
| (A2-1) | | | | |
| Component (B): initiator for cationic polymerization [% by weight] | | | | |
| (B1-1) | 1.0 | 1.0 | 1.0 | 1.0 |
| (B1-2) | | | | |
| (B2-1) | 1.5 | 1.5 | 1.5 | 1.5 |
| Component (C): flame retardant [% by weight] | | | | |
| (C1-1) | 20.0 | 5.0 | | 0 |
| (C2-1) | 0 | 10.0 | | 20.0 |
| (C4) | | | 20.0 | |
| (C1):(C2) ratio | | 1:2 | | |
| Component (D): filler [% by weight] | | | | |
| (D1) | 43.3 | 43.3 | 34.6 | 0 |
| (D2) | 6.0 | 6.0 | 4.8 | 0 |
| (D3) | 0.7 | 0.7 | 0.6 | 0 |
| (D4) | | | | |
| (D5) | | | | |
| (D6) | | | | |
| Component (E): additives [% by weight] | | | | |
| | 1.7 | 1.7 | 1.7 | 1.7 |
| Properties of the compositions | | | | |
| Viscosity | 252170 | 22860 | 6002 | 2589 |
| 10 · 1/s | | | | |
| [mPa*s] | | | | |
| Fire protection | V-0 | — | n.d. | — |
| class | | | does not cure | |
| Solids content | 71 | 56 | 41 | 0 |
| [% by weight] | | | | |
| DSC onset | 97 | 95 | 107 | 93 |
| [° C.] | | | | |
| Phosphorus content | 4.74 | 2.08 | 5.08 | 1.78 |
| [% by weight] | | | | |

Examples 1 to 3 each contain 20% by weight of the organophosphinate (C1) as a flame retardant, and various amounts of inorganic fillers (D). Example 1 is free of additional fillers (D). In all cases, fire protection class UL94 V-0 is achieved. The onset temperature of less than 100° C. shows a high reactivity of the compositions. Due to their low viscosity the compositions can be well dosed and are suitable for both adhesive applications and use in encapsulating applications. Each composition contains both a photoinitiator for cationic polymerization (B1) and a thermally activatable initiator (B2), and is thus dual curing.

Examples 4 and 5 show compositions with only 10% by weight of the organophosphinate (C1) and various proportions of fillers. Even with relatively low proportions of component (C1) fire protection class UL94 V-0 can be achieved while keeping the viscosity of the compositions low by adding the further phosphorus-containing flame retardant (C2).

Example 6 shows an oxetane-containing system which, despite a high solids content of about 60% by weight, has a viscosity of 7.748 mPa*s and thus still exhibits very good flowability. Therefore, the composition is very suitable for encapsulating applications.

Example 7 contains corundum instead of quartz as a filler (D). The cured compositions achieve the same degree of fire protection according to fire protection class UL94 V-0 as the other examples. With a value of about 10,000 mPa*s the viscosity of the liquid composition is low, thus ensuring good dosing properties.

Examples 8 to 10 show compositions with various initiator systems for cationic polymerization. Example 8 is a photocuring composition, while example 9 is an exclusively heat-curing composition. The composition of example 10 contains, in addition to the photoinitiator (B1-1), another photoinitiator (B1-2) based on a ferrocenium salt. By adding another initiator, the compositions can be pre-activated by irradiation with a first wavelength and fixed and/or cured by irradiation with a second wavelength. The composition of example 10 is thus also suitable for use in a flow activation device.

Comparative example 11 has a solids content of components (C), (D) and (E) of more than 70% by weight and is no longer flowable due to its viscosity of more than 250,000 mPa*s.

Comparative example 12 contains less than the required amount of the organophosphinate (C1). The cured composition does not pass the fire protection test despite the addition of another phosphorus-containing flame retardant (C2).

In the composition of comparative example 13 a traditional flame retardant is used. This inhibits curing of the composition.

In comparative example 14 no flame retardant based on an organophosphinate (C1) is used. Instead, it contains only the phosphate ester (C2). The cured composition does not achieve sufficient flame retardancy.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A cationically polymerizable composition that is solvent-free and liquid at room temperature, comprising:
(A) at least one cationically polymerizable component in a proportion of 15 to 80% by weight;
(B) at least one initiator for cationic polymerization;
(C) at least one flame retardant, with the flame retardant comprising at least 10% by weight of an organophosphinate, based on the total weight of the composition; and
(D) 0 to 60% by weight of a filler;
wherein the solids content from components (C) and (D) is at most 70% by weight, each based on the total weight of the composition.

2. The cationically polymerizable composition according to claim 1, wherein the cationically polymerizable component (A) is selected from the group of epoxy-containing compounds (A1) and oxetane-containing compounds (A2) as well as combinations thereof, with the cationically polymerizable component (A) preferably comprising an epoxy-containing compound (A1) and additionally an oxetane-containing compound (A2).

3. The cationically polymerizable composition according claim 1, wherein the cationically polymerizable component (A) comprises at least one aromatic epoxy compound (A1).

4. The cationically polymerizable composition according to claim 1, wherein the organophosphinate (C1) is present in a proportion of 10 to 30% by weight, preferably at least 15% by weight and more preferably at least 20% by weight.

5. The cationically polymerizable composition according to claim 1, wherein the proportion of fillers (D) is from 5 to 50% by weight, preferably 15 to 40% by weight.

6. The cationically polymerizable composition according to claim 1, wherein the composition contains the filler in a proportion of 0 to 10% by weight, and the proportion of the organophosphinate is at least 20% by weight.

7. The cationically polymerizable composition according to claim 1, wherein the flame retardant (C) comprises another phosphorus-containing flame retardant (C2) in a proportion of 0 to 40% by weight, based on the total weight of the composition.

8. The cationically polymerizable composition according to claim 7, wherein the further phosphorus-containing flame retardant (C2) is present in a proportion of at least 5% by weight, the proportion of the organophosphinate is in a range of 10 to 15% by weight and the proportion of the filler (D) is from 0 to 60% by weight.

9. The cationically polymerizable composition according to claim 1, wherein the composition comprises a mixture of initiators for cationic polymerization or that the composition comprises at least one photoinitiator based on metallocenium, preferably a mixture of photoinitiators (B1) which can be activated at various excitation wavelengths, more preferably a mixture of photoinitiators based on metallocenium and based on onium compounds.

10. The cationically polymerizable composition according to claim 9, wherein the photoinitiators based on metallocenium have an excitation wavelength in the range of 400 to 700 nm, and the photoinitiators based on onium compounds have an excitation wavelength in the range of 200 to 380 nm.

11. A method for joining, encapsulating or coating substrates, comprising the following steps:
a) providing the composition according to claim 1;
b) activating the composition by actinic radiation in a flow device;
c) dosing the composition onto a first substrate;
d) supplying a second substrate to the composition; and
e) fixing and/or curing the composition by irradiation with actinic radiation; and
f) heating the composition and the substrate and/or the substrate composite.

12. The use of a cationically polymerizable composition according to claim 1 for encapsulating of electronic parts.

13. An article, available by using a cationically polymerizable composition according to claim 1, with the composition cured and the article having a flame retardancy according to fire protection class UL94 V-0.
